(19) United States
(12) Patent Application Publication
(10) Pub. No.: US 2007/0153415 A1
(43) Pub. Date: Jul. 5, 2007

(54) Constrained-damped boundary apparatus for reduction of HDD flex cable induced settle dynamics

(76) Inventors: Jen-Yuan Chang, San Jose, CA (US); Ta-Chang Fu, San Jose, CA (US); Edgar D. Rothenberg, San Jose, CA (US); See C. Young, San Jose, CA (US)

Correspondence Address: WAGNER, MURABITO & HAO LLP, 123 Westridge Drive, Watsonville, CA, 95076, US

(21) Appl. No.: 11/325,889

(22) Filed: Jan. 4, 2006

(51) Int. Cl. G11B 5/012

(52) U.S. Cl. 360/97.01

(57) ABSTRACT

A flex cable assembly has a flex cable with at least one distal end. At least one clamping device is coupled to at least one distal end, wherein at least one of the clamping device allows coupling to an actuator assembly and/or a base casting.

### TECHNICAL FIELD

This invention relates generally to the field of direct access storage devices and in particular to controlling the vibration of the flex cable dynamic loop.

### BACKGROUND ART

Direct access storage devices (DASD) have become part of every day life, and as such, expectations and demands continually increase for greater speed for manipulating data and for holding larger amounts of data. To meet these demands for increased performance, the mechanical assembly in a DASD device, specifically the Hard Disk Drive (HDD) has undergone many changes.

Shown in FIG. 1 is a plan view of an HDD with its cover and top magnet removed to show the relationship of components and sub-assemblies of the HDD. The dynamic performance of HDD 110 is a major mechanical factor for achieving higher data capacity as well as for manipulating this data faster. The dynamic performance of HDD 110 is dependant upon the dynamic performance of its individual components and sub-assemblies. Many factors that influence the dynamic performance are intrinsic to the individual components. Some of these intrinsic factors are in general: mass of the component; stiffness of the component; and geometry of the component. This is not an all-inclusive list and those schooled in engineering or HDD technology will understand that there are many other factors that influence dynamic performance of HDD 110 components and sub-assemblies. A sub-set of dynamic performance of an HDD is the settle dynamics of the HDD. Settle dynamics of an HDD in brief is the manner in which all the components involved with positioning magnetic head 156 will stop vibrating and allow magnetic head 156 to be positioned over a desired data track 156. Settle dynamics is important for determining the rate at which data can be transferred to and from data tracks 136 as well as the quantity of data tracks that can be written on disk surface 135.

There are several sources for vibration energy that act on actuator 140. One source of vibration energy inside HDD 110 is the motion of dynamic loop 119 of flex cable 118. Dynamic loop 119 is required for proper arcuate movement of actuator 140. However, as dynamic loop 119 moves and changes its curvature with the motion of actuator 140, dynamic loop 119 can vibrate and transmit these vibrations into actuator 140 and thus affect the settle dynamics of magnetic head 156.

Prior to recognizing the deleterious affects of dynamic loop vibrations on settle dynamics of magnetic head 156, flex cable 118 was attached to controller 117 and actuator 140 by a combination of holes in flex cable 118 that aligned to pins in actuator 140 and controller 117. After attaching flex cable 118 to controller 117 and actuator 140, the ends of the pins were deformed to trap flex cable 118 onto the pins. A similar approach to alignment holes and pins in flex cable 118 was to fabricate flex cable 118 with detents that aligned with features on controller 117 and actuator 140. The intent of a loose attachment of flex cable 118 to controller 117 and/or actuator 140 was to allow dynamic loop 119 to assume a natural shape and have minimal effect on the motion of actuator 140. The disadvantages to these approaches are similar in that they both did not constrain flex cable 118 and its resulting dynamic loop 119 so as to control the vibrations of dynamic loop 119. Also valuable real estate on flex cable 118 was consumed by holes and detents.

After recognizing that it is desirable to control the vibration of dynamic loop 119, attempts were made to control the vibration of dynamic loop 119 through various techniques, all of which have problems with implementation.

One approach to controlling dynamic loop 119 vibrations is to optimize its shape and curvature. However, dynamic loop 119 is a product of an assembly process, which typically involves assembling one end of flex cable 118 to actuator 140, and the other end of flex cable 118 to controller 117. Actuator 140 and controller 117 with flex cable 118 attached are assembled into base casting 113. These assembly process steps as well as the manufacturing tolerances of the components affect the final shape of dynamic loop 119, and although an optimum shape for dynamic loop 119 may be known, it is difficult if not impossible to achieve with the compounding of assembly and component tolerances.

Another approach to controlling dynamic loop 119 vibrations is to affix it to actuator 140 and controller 117 in a secure manner. Secure attachment techniques typically involved adhesives. A derivation of adhesive attachment was to use a pressure sensitive adhesive that also had vibration damping characteristics. There are a couple of problems with these techniques. If flex cable 118 is securely attached to actuator 140 and controller 117 or to one or the other, the tolerances involved with assembling flex cable 118 to actuator 140, and to controller 117, and into base casting 113 will cause the resulting dynamic loop 119 to be constrained in an unnatural shape and hence put extra load on the VCM (voice coil motor comprising voice coil 143 and magnets 125). All adhesives including those with the characteristics of vibration damping tend to delaminate from flex cable 118 at the boundary where dynamic loop 119 begins. With a secure adhesive attachment technique, flex cable 118 can also delaminate at the boundary where the dynamic loop 119 begins.

### SUMMARY OF THE INVENTION

Various embodiments of the present invention are described herein. A flex cable assembly has a flex cable with at least one distal end. At least one clamping device is coupled to at least one distal end, wherein at least one of the clamping device allows coupling to an actuator assembly and/or a base casting.

### BRIEF DESCRIPTION OF THE DRAWINGS

The accompanying drawings, which are incorporated in and form a part of this specification, illustrate embodiments of the invention and, together with the description, serve to explain the principles of the invention:

Prior Art FIG. 1 is a plan view of an HDD with cover and top magnet removed.

FIG. 2A is a plan view of an HDD with cover and top magnet removed as embodied in the present invention.

FIG. 2B is an isometric blow-apart of an HDD as embodied in the present invention.

FIG. 3 is a diagrammatic representation of clamping means for a dynamic loop of a flex cable assembly as embodied in the present invention.

FIG. 4 is an isometric detail of a flex cable assembly as embodied in the present invention.

### DETAILED DESCRIPTION

One embodiment of the present invention addresses the challenges presented by the cited prior art while achieving flexibility in the assembly process, and minimizing the effect of flex cable vibrations on the HDD settle dynamics.

As presented in the prior art, it is desirable to have dynamic loop 119 take a naturally curved shape without restrictions. Restricting dynamic loop 119 during assembly and forcing it into an unnatural shape will cause dynamic loop 119 to be stiffer than if it had a natural curvature and apply a varying and resisting torque on the VCM during accessing of actuator 140.

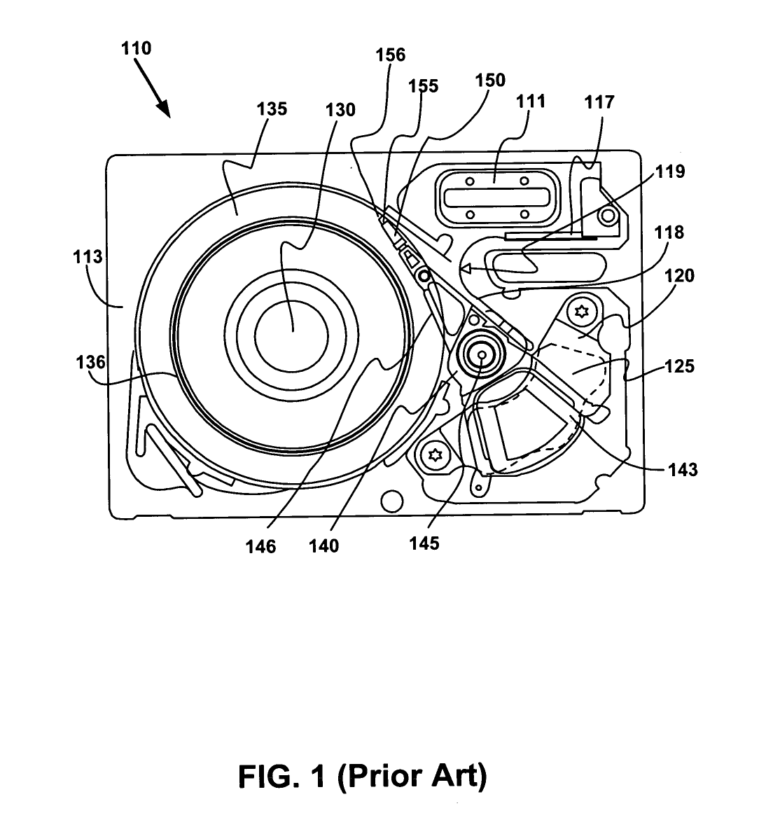

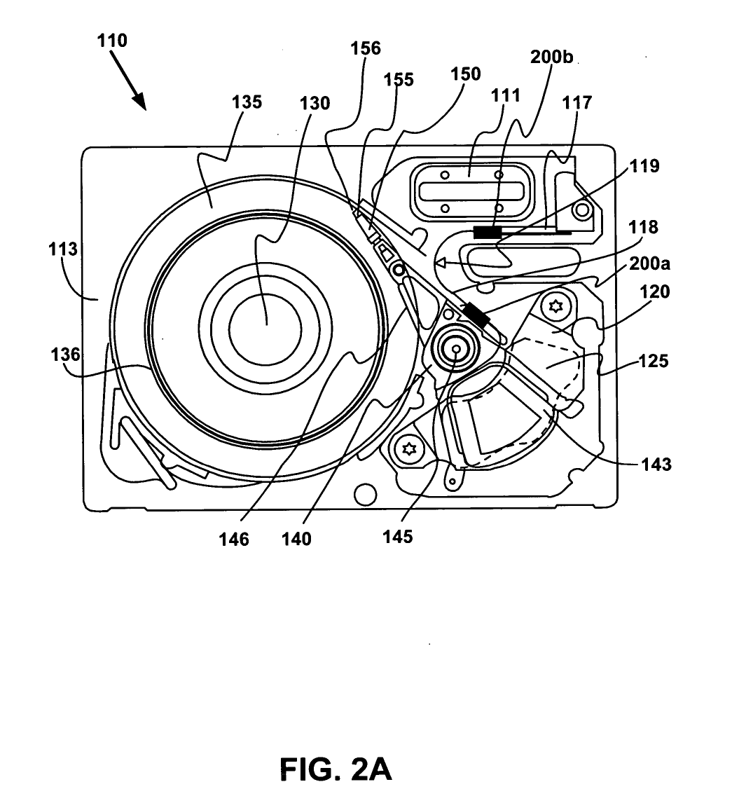

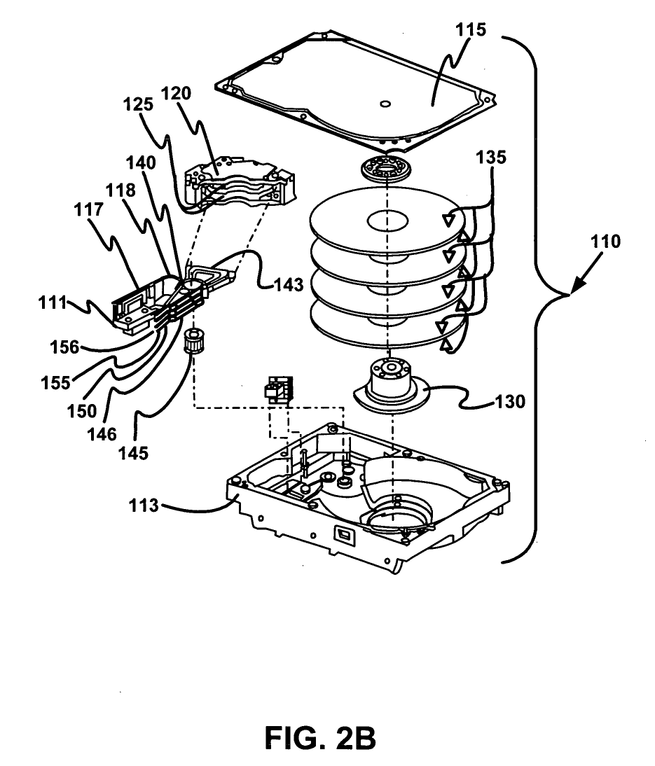

Shown in FIG. 2A is the relationship of components and sub-assemblies of HDD 110 and a representation of data tracks 136 recorded on disk surface 135. The cover is removed and not shown so that the inside of HDD 110 is visible. FIG. 2B shows a similar HDD 110, but with all its components in an isometric blow-apart view. The components are assembled into base casting 113, which provides attachment and registration points for components and sub-assemblies. Data is recorded onto disk surface 135 in a pattern of concentric rings known as data tracks 136. Disk surface 135 is spun at fast revolutions by means of a motor-hub assembly 130. Data tracks 136 are recorded onto disk surface 135 by means of magnetic head 156, which typically resides at the end of slider 155. FIG. 2A being a plan view shows only one head and one disk surface combination. It should be appreciated that what is described for one head-disk combination applies to multiple head-disk combinations. The embodied invention is independent of number of head-disk combinations. Slider 155 and consequently head 156 are incorporated into head gimbal assembly (HGA) 150. HGA 150 is incorporated into actuator 140, which is comprised of at least one arm 146, pivot bearing 145, and voice coil 143. Arm 146 supports HGA 150 over disk surface 135. Pivot bearing 145 allows for smooth and precise rotation of actuator 140. Actuator 140 precisely moves HGA 150 over disk surface 135 by means of electromotive force (emf) produced between voice coil 143 and magnets 125. Emf is a force that is produced when a current is passed through voice coil 143 and is in close proximity to magnets 125. Only bottom magnet 125 is shown. Top and bottom magnets 125 are joined as pole piece assembly 120. Pole piece assembly 120 in conjunction with voice coil 143 constitutes a voice coil motor (VCM). The VCM positions head 156 via actuator 140 by producing a controlled emf. Current is passed through voice coil 143 from controller 117. The required amount of current from controller 117, to produce the desired amount of emf, is determined by location information (stored in other electronic components not shown in FIG. 1A) for data tracks 136 and location information stored in data tracks 136. Electronic commands for accessing data tracks 136 pass from controller 117 through flex cable 118 and into voice coil 143. Small corrections to the position of head 156 are determined from retrieved information from data tracks 136. This retrieved information is sent back to controller 117 so that small corrections can be made to the location and the appropriate current can be sent from controller 117 to voice coil 143. Once the desired data track is located, data is either retrieved or manipulated by means of electronic signals that pass through connector 111 and through flex cable 118. Connector 111 is the electronic interface that allows data to be transferred in and out of HDD 110.

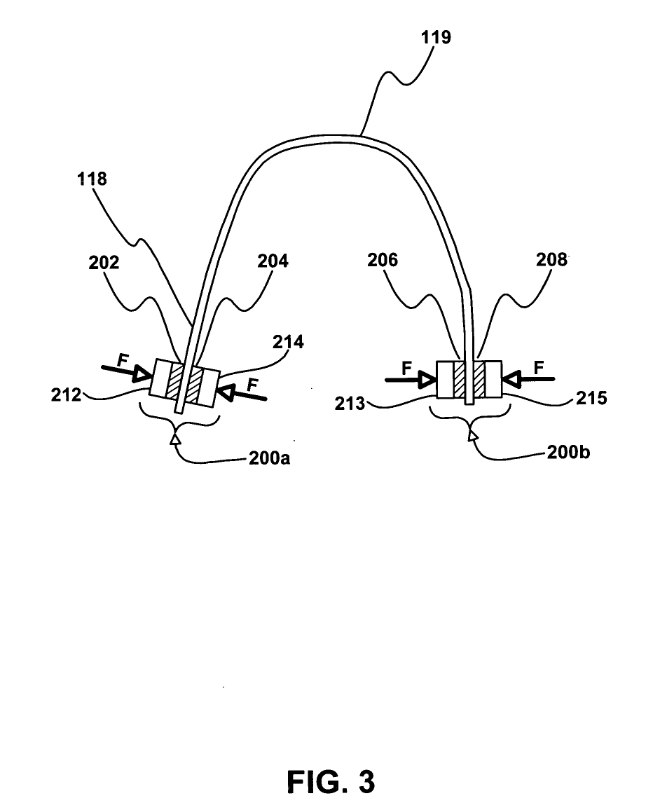

Referring to FIG. 3, one embodiment in accordance with the present invention is presented in a diagrammatic form. Two clamping means, 200a and 200b constrain flex cable 118 at both ends to form dynamic loop 119. (Clamping means 200a and 200b are also presented in FIG. 2A.) Clamping means 200a is associated with the end of flex cable 118 that is coupled to actuator 140. Clamping means 200b is associated with the end of flex cable 118 that is coupled to base casting 113. The function of clamping means 200a and 200b are similar, and the discussion of one applies to the other. Clamping means 200a (also referring to clamping means 200b) is comprised of a movable half 212 and a fixed half 214. Movable half 212 exerts a force F onto fixed half 214 that is opposed by an equal force F from fixed half 214. These opposing forces hold flex cable 118 in a clamped fashion and constraining the motion of flex cable 118. The material characteristics for clamping material 202 and 204 can be chosen to groom the dynamic characteristics of dynamic loop 119. At one extreme, clamping material 202 and/or 204 can be very rigid and hold flex cable 118 in a firm and immovable manner. Or clamping material 202 and/or 204 can have vibration damping characteristics that attenuate the vibration of dynamic loop 119.

The various tolerances that affect the natural curvature of dynamic loop 119 can be negated by engaging movable half 212 to fixed half 214 after actuator 140 is coupled to base casting 113. The various tolerances that affect the natural curvature of dynamic loop 119 can also be minimized by engaging movable half 212 to fixed half 214 after fabrication of a flex cable assembly. A flex cable assembly can vary in configuration depending on the HDD design. In general, a flex cable assembly comprises a flex cable, coupled at one end to a means for coupling to an actuator, and coupled at another end to a means for coupling to a base casting.

It should be appreciated that the clamping means embodied in accordance with the present invention can be fabricated as a separate component or as part of the coupling means for coupling to an actuator, and/or as part of the coupling means for coupling to a base casting. It should also be appreciated that clamping means 200a embodied in accordance with the present invention can exist by itself or in conjunction with clamping means 200b. One skilled in the art will recognize that clamping means 200b embodied in accordance with the present invention can exist by itself or in conjunction with clamping means 200a. One skilled in the art will also recognize that clamping material 202 and 204 embodied in accordance with the present invention can both have the characteristic of being rigid or vibration damping; or clamping material 202 can be rigid and clamping material 204 can be vibration damping; or clamping material 202 can be vibration damping and clamping material 204 can be rigid. It should be appreciated that clamping material 206 and 208 embodied in accordance with the present invention can both have the characteristic of being rigid or vibration damping; or clamping material 206 can be rigid and clamping material 208 can be vibration damping; or clamping material 206 can be vibration damping and clamping material 208 can be rigid. It should also be appreciated that clamping material 202, 204, 206, and 208 can be integrally fabricated into clamping means 200a and 200b. One skilled in the art will also recognize that clamping material 202, 204, 206, and 208 can be of a non-adhesive nature.

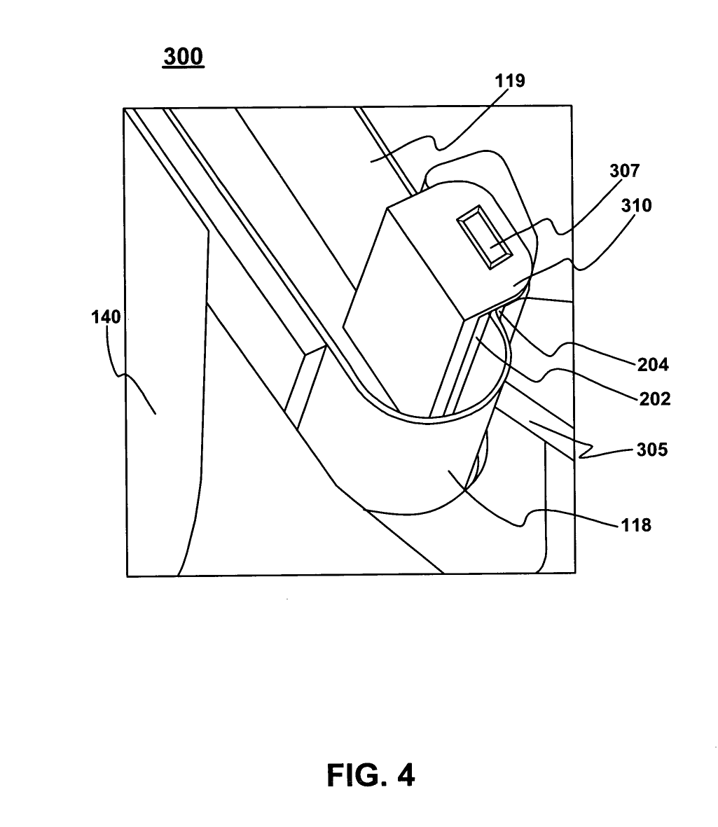

FIG. 4 shows detail 300 of one embodiment in accordance with the present invention. Advantage is taken of existing J-block 305 as a means of incorporating a clamping device. One purpose of J-block 205 is to provide an exit point of flex cable 118 from actuator 140 so that dynamic loop 119 can be formed in a controlled manner. Clip 310 can be fabricated as a separate component or as an integral part of J-block 205. With flex cable 118 properly located between clamping material 202 and 204, clip 310 is engaged with protrusion 307 on J-block 305 and thusly constrain flex cable 118 and control dynamic loop 119.

Advantageously, the present invention, in the various presented embodiments allows for reducing flex cable induced settle dynamics by controlling the boundary conditions of the flex cable dynamic loop 119. The settle dynamics caused by dynamic loop 119 are improved through the various presented embodiments in accordance with the present invention by: rigidly constraining dynamic loop 119 in a controlled and repeatable manner; damping the vibration of dynamic loop 119 in a controlled and repeatable manner; and allowing dynamic loop 119 to have a natural curvature with the least possible affect on VCM torque.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A disk drive assembly comprising:
a base casting for providing attachment points for the major components of said disk drive assembly;
a motor-hub assembly to which at least one disk is coupled allowing rotation of said disk about an axis approximately perpendicular and centered to said disk, wherein said motor-hub assembly is attached to said base casting, wherein said disk comprising at least one surface of data tracks;
a magnetic head for reading and writing said data tracks onto said surface;
a slider consisting of said magnetic head and an attachment means to a suspension, wherein said suspension is attached to an arm;
an actuator assembly comprising:
at least one said arm coupled to at least one said suspension;
a pivot means coupled to said base casting allowing said actuator to move said magnetic head arcuately across said data tracks; and
a flex cable using a clamping device to couple at least one distal end to said actuator assembly and to said base casting.

2. The disk drive assembly of claim 1 wherein at least one said clamping device comprises vibration damping material coupled to at least one surface of said flex cable.

3. The disk drive assembly of claim 1 wherein at least one said clamping device comprises rigidly constraining material coupled to at least one surface of said flex cable.

4. The disk drive assembly of claim 2 wherein at least one said vibration damping material is integrally coupled to said clamping device.

5. The disk drive assembly of claim 2 wherein at least one said vibration damping material comprises non-adhesive material.

6. A flex cable assembly comprising:
a flex cable;
at least one distal end; and
at least one clamping device coupled to at least one said distal end, wherein at least one said clamping device allows coupling to an actuator assembly and a base casting.

7. The flex cable assembly of claim 6 wherein said clamping device coupling said flex cable to said actuator assembly comprising:
vibration damping material coupled to at least one surface of said flex cable; and
said similar clamping device coupling said flex cable to base casting comprising:
vibration damping material coupled to at least one surface of said flex cable.

8. The flex cable assembly of claim 6 wherein said clamping device coupling said flex cable to said actuator assembly comprising:
rigidly constraining material coupled to at least one surface of said flex cable; and
said similar clamping device coupling said flex cable to base casting comprising:
rigidly constraining material coupled to at least one surface of said flex cable.

9. The flex cable assembly of claim 6 wherein said clamping device coupling said flex cable to said actuator assembly comprising:
vibration damping material coupled to at least one surface of said flex cable; and
said similar clamping device coupling said flex cable to base casting comprises rigidly constraining material coupled to at least one surface of said flex cable.

10. The flex cable assembly of claim 6 wherein said clamping device coupling said flex cable to said actuator assembly comprising:
rigidly constraining material coupled to at least one surface of said flex cable; and
said similar clamping device coupling said flex cable to base casting comprising:
vibration damping material coupled to at least one surface of said flex cable.

11. The clamping device of claim 7 wherein said vibration damping material is integrally coupled to said clamping device.

12. The clamping device of claim 9 wherein said vibration damping material is integrally coupled to said clamping device.

13. The clamping device of claim 10 wherein said vibration damping material is integrally coupled to said clamping device.

14. The clamping device of claim 7 wherein said vibration damping material comprises non-adhesive material.

15. The clamping device of claim 9 wherein said vibration damping material comprises non-adhesive material.

16. The clamping device of claim 10 wherein said vibration damping material comprises non-adhesive material.

17. A flex cable assembly comprising:
means for conducting data signals between an actuator assembly and a base casting; and
means for clamping at least one distal end of said means for conducting data signals to an actuator assembly and base casting.

18. The flex cable assembly of claim 17 wherein at least one said means for clamping comprises:
a means for damping vibration; and
a means for coupling said means for damping vibration to at least one surface of said means for conducting data signals.

19. The flex cable assembly of claim 17 wherein at least one said means for clamping comprises:
means for rigidly constraining at least one surface of said means for conducting data signals.
